(19) United States
(12) Patent Application Publication
(10) Pub. No.: US 2012/0212186 A1
(43) Pub. Date: Aug. 23, 2012

(54) CHARGING APPARATUS AND CHARGING METHOD FOR LITHIUM RECHARGEABLE BATTERY

(75) Inventors: Hiroki Fujii, Kariya-city (JP); Naomi Awano, Nagoya-city (JP); Tomoki Yamane, Nagoya-city (JP)

(73) Assignee: DENSO CORPORATION, Kariya-city (JP)

(21) Appl. No.: 13/371,764

(22) Filed: Feb. 13, 2012

(30) Foreign Application Priority Data
Feb. 21, 2011 (JP) 2011-034073

(51) Int. Cl. H02J 7/00

(52) U.S. Cl. 320/137; 320/107

(57) ABSTRACT

In a charging apparatus, a lithium rechargeable battery includes positive and negative electrodes containing active materials that allow absorption and discharge of lithium ions, and an electrolyte. The lithium rechargeable battery contains, in at least one of the electrolyte and the positive electrode, an oxidizable agent which is oxidizable by the positive electrode and which has an oxidation potential greater than a nominal voltage of the lithium rechargeable battery and less than a decomposition potential of the electrolyte. The charging apparatus includes a battery capacity recovering unit that charges the lithium rechargeable battery at a potential equal to or greater than the oxidation potential of the oxidizable agent in a part of a plurality of number of times of charging and discharging cycles.

### CROSS REFERENCE TO RELATED APPLICATION

This application is based on Japanese Patent Application No. 2011-34073 filed on Feb. 21, 2011, the disclosure of which is incorporated herein by reference.

### TECHNICAL FIELD

The present disclosure relates to a charging apparatus and a charging method for a lithium rechargeable battery.

### BACKGROUND

With rapid market expansion of portable electronic devices, such as a laptop computer or a cell phone, small-sized high-capacity rechargeable batteries with a high energy density and excellent charging/discharging cycle characteristics have been increasingly required for use in these electric devices. In order to satisfy the above requirements, rechargeable batteries have been developed in which an electrochemical reaction is caused by the transmission and reception of charges using lithium ions as a charge carrier.

The lithium battery has a drawback of gradually reducing its battery capacity, which is evaluated as cycle characteristics. One cause for reduction in battery capacity is that lithium ions which are to be reversibly absorbed or discharged are consumed and inactivated by a side reaction with a carbon negative electrode due to the storage of the battery or the repetition of charging and discharging.

For example, JP2009-252489A, which corresponds to US2011/0104564A1 and is hereinafter referred to as Patent Document 1, describes a method of improving cycle characteristics of a lithium rechargeable battery which respectively includes LiFePO₄ as a positive-electrode active material, a carbon material as material for a negative electrode, and LiPF₆ and LiBOB (lithium bis(oxalate)borate) as a nonaqueous electrolyte solution. In Patent Document 1, a charging potential is increased to 4.3 V or more until an initial charging/discharging cycle (from the first to fifth cycle), so that BOB anions derived from the LiBOB contained in the nonaqueous electrolyte solution are oxidized and decomposed to form a decomposition product of the BOB anions. The thus-obtained decomposition product of the BOB anions is covered with the positive-electrode active material, which achieves the lithium rechargeable battery with excellent cycle characteristics.

As another example, JP2008-270201A, which is hereinafter referred to as Patent Document 2, describes a positive electrode material for a lithium ion battery which is subjected to oxidation. The positive electrode material is represented by a general formula: xLiMO₂.(1-x)LiNO₃ (in which x satisfies a value of greater than zero and less than 1 (0<X<1), M is one or more transition metal element having an average oxidation number of +3, and N is one or more transition metal element having an average oxidation number of +4).

Also, JP2008-167642A, which corresponds to US2008/0129252A1, describes a positive electrode material for a lithium ion battery having high capacity and suppressing deterioration in charge at high potential.

### SUMMARY

The technologies as described in Patent Document 1 and Patent Document 2 can provide the battery with excellent cycle characteristics, but cannot recover its reduced battery capacity

The inventors have been dedicated to studying taking into consideration the above circumferences, and as a result, had findings about a method for recovering a reduced battery capacity by improving a charging and discharging method.

The present disclosure has been made in view of the forgoing findings, and thus it is an object of the present disclosure to provide a charging apparatus for a lithium rechargeable battery, which is capable of improving the reduced battery capacity. It is another object of the present disclosure to provide a charging method for a lithium rechargeable battery, which is capable of improving the reduced battery capacity.

A charging apparatus according to an aspect is adapted to charge a lithium rechargeable battery which includes positive and negative electrodes containing active materials that allow absorption and discharge of lithium ions, and an electrolyte. The lithium rechargeable battery contains, in at least one of the electrolyte and the positive electrode, an oxidizable agent which is oxidizable by the positive electrode and which has an oxidation potential greater than a nominal voltage of the lithium rechargeable battery and less than a decomposition potential of the electrolyte. The charging apparatus includes a battery capacity recovering unit that charges the lithium rechargeable battery at a potential equal to or greater than the oxidation potential of the oxidizable agent in a part of a plurality of number of times of charging and discharging cycles.

The lithium rechargeable battery of interest to be charged includes the oxidizable agent, which is oxidizable at the positive electrode and which has the oxidation potential greater than the nominal voltage of the lithium rechargeable battery and less than the decomposition potential of the electrolyte. The charging apparatus includes the means or unit for increasing a charging potential up to a potential at which the oxidizable agent can be oxidized and decomposed.

When charging the related art lithium rechargeable battery, a lithium is discharged from the positive electrode, and the lithium is introduced into the negative electrode, which does not change the total amount of lithium within the positive and negative electrodes. However, when the rechargeable battery contains the oxidizable agent, the oxidizable agent is oxidized upon charging, whereby the lithium can be introduced into the negative electrode without the reversible oxidation-reduction reaction including insertion and discharge of lithium at the positive electrode. As a result, the amount of active lithium is increased to thereby increase the battery capacity.

In the charging apparatus according to the first aspect, the frequency of oxidation and decomposition of the oxidizable agent is restricted by increasing the charging potential, which can suppress the adverse effect on components of the battery.

A charging method according to an aspect is directed to a method for charging a lithium rechargeable battery which includes positive and negative electrodes containing active materials that allow absorption and discharge of lithium ions, and an electrolyte. The lithium rechargeable battery contains an oxidizable agent which is oxidizable by the positive electrode and which has an oxidation potential greater than a nominal voltage of the lithium rechargeable battery and less than a decomposition potential of the electrolyte. In the method, a battery capacity is recovered by charging the lithium rechargeable battery at a potential equal to or greater than the oxidation potential of the oxidizable agent at a frequency of one or more number of times in a plurality of number of times of charging and discharging cycles.

In the method, the charging potential is increased to a potential at which the oxidizable agent contained in and oxidizable by the positive electrode can be oxidized. The oxidizable agent has the oxidation potential greater than the nominal voltage of the lithium rechargeable battery and less than the decomposition potential of the electrolyte. As a result, the oxidation of the oxidizable agent can insert the lithium of the electrolyte into the negative electrode without the reversible oxidation-reduction reaction including insertion and discharge of lithium at the positive electrode, thereby to recover the battery capacity.

In the method, the frequency of increasing the charging potential is restricted, which can suppress the adverse effect on the components of the battery.

### BRIEF DESCRIPTION OF THE DRAWINGS

Other objects, features and advantages of the present disclosure will become more apparent from the following detailed description made with reference to the accompanying drawings, in which like parts are designated by like reference numbers and in which:

FIG. 1 is a schematic cross-sectional view of a coin type battery used in an example according to an embodiment;

FIG. 2 is a block diagram of a charging apparatus of the example according to the embodiment;

FIG. 3 is a flowchart showing a control method of the charging apparatus of the example according to the embodiment; and

FIG. 4 is a graph showing the effect of a battery capacity recovering step on cycle characteristics due to the presence or absence of a lithium salt B in the example according to the embodiment.

### DETAILED DESCRIPTION

Exemplary embodiments of a charging apparatus and a charging method for a lithium rechargeable battery (lithium secondary battery) will be described hereinafter with reference to the drawings.

<Lithium Rechargeable Battery to which Charging Apparatus for Lithium Secondary Battery and Charging Method can be Applied>

A lithium rechargeable battery to which the charging apparatus and the charging method according to an embodiment can be applied includes positive and negative electrodes containing active materials that allow absorption and discharge of lithium ions, and an electrolyte. The lithium rechargeable battery also includes other components selected if necessary which include a separator intervening in between the positive and negative electrodes, electrode parts, a case, and the like.

The lithium rechargeable battery of the embodiment further includes an oxidizable agent. The oxidizable agent is included in at least one of the electrolyte and the positive electrode. The oxidizable agent can be provided in the form of liquid, solid, and the like, and can be dissolved or dispersed in at least one of the electrolyte and the positive electrode.

The oxidizable agent is a compound that reacts itself to recover a battery capacity. As the amount of added oxidizable agent is increased, the degree of recovery of the battery capacity becomes more. When the oxidizable agent decreases the conductivity of the electrolyte, or when a reaction product of the oxidizable agent serves as a resistance factor, as the amount of added oxidizable agent becomes smaller, the reduction in battery capacity or output at an initial time can be minimized. Thus, the amount of added oxidizable agent is determined so as to provide necessary characteristics, taking into consideration the effect of recovery of the battery capacity, and the balance between the battery capacity and the output at the initial time. For example, in the case of addition of the oxidizable agent into the electrolyte, the amount of addition of the, oxidizable agent can be in a range of about 0.05 mol/L to 1.0 mol/L respective to the entire electrolyte as the reference.

The oxidizable agent has an oxidation voltage greater than the nominal voltage of the lithium rechargeable battery of interest and less than the decomposition potential of the electrolyte. For example, the compound having an oxidation potential greater than the upper limit of voltage in normal use by 0.1 V or more is selected as a component of the oxidizable agent, whereby the oxidizable agent can be decomposed when necessary without being decomposed in the normal use of the lithium rechargeable battery to thereby recover the lithium rechargeable battery. The oxidation potential is a value obtained by measuring a current with respect to a change in voltage applied to the material by a cyclic voltammetry.

The oxidizable agent includes one or more compounds selected from the group consisting of lithium bis(oxalate)borate (LiBOB), lithium difluoro oxalate borate(LiFOB), Li₂B₁₂F₁₂, boryl lithium, a Li salt of tetramethyl boron, a Li salt of tetraethylboron, a Li salt of tetrapropylboron, a Li salt of tetrabutylboron, a Li salt of trimethylethylboron, a Li salt of trimethylbenzylboron, a Li salt of trimethylphenylboron, a Li salt of triethylmethylboron, a Li salt of triethylbenzylboron, a Li salt of triethylphenylboron, a Li salt of tributylmendylboron, a Li salt of tributylphenylboron, a Li salt of tetraphenylboron, a Li salt of benzyltriphenylboron, a Li salt of methyltriphenylboron, a Li salt of buthyl triphenyl boron, a Li salt of tetramethylboron, bis(ethylenedithio)tetrathiafulvalene, benzoquinone, benzotriazole, naphthoquinone, fluorene, polyaniline, polypyrrole, polyethylene dioxythiophene, 4-aminopyridine, 2-aminopyridine, N,N-dimethyl-4-aminopyridine, 4-diethylaminopyridine, 2-hydroxypyridine, 2-methoxypyridine, 4-methoxypyridine, 2-dimethylaminoimidazole, 2-methoxyimidazole, imidazole, 2-mercaptoimidazole, 2-methylimidazole, aminoquinoline, LiClO₄, LiAlCl₄, LiAsF₆, LiBF₄, LiPF₆, LiSbF₆, LiB₁₀C₁₀, LiCF₃SO₃, LiCF₃CO₂, LiCl, LiBr, LiI, lithium lower aliphatic carboxylate, lithium chloloborane, (2,4-pentanedionato)lithium, lithium 1,1,2,2,3,3-hexafluoropropane-1,3-disulfonimide, lithium acetate, lithium acetoacetate, lithium bis(trifluoromethanesulfonyl)imide, lithium carbonate, lithium diisopropyl amide, lithium-2-hydroxybutyrate, lithium formate, lithium hexamethyldisilazide, lithium-2-hydroxypropionate, lithium pyruvate, lithium tetrakis(pentafluorophenyl)borate, lithium trifluoromethanesulfonate, methyllithium, phenyllithium, dilithium phthalocyanine, lithium salicylate, tert-butyllithium, LiNH₂SO₃, Li₄SiO₄, Li₃PO₄, Li₂TiO₃, Li₂ZrO₃, Li₂AlO₂, Li₄ZrO₄, Li₄GeO₄, Li₂S—SiS₂—Li₄SiO₄, Li₂O—Nb₂O₅, Li₂O—B₂O₃—LiCl, and Li₂S—P₂S₅. These compounds have the respective oxidation potentials. The oxidizable agent to be actually used is appropriately selected based on the nominal voltage of the lithium rechargeable battery applied and the oxidation decomposition potential of the component included in the rechargeable battery.

Some of these compounds described above cannot be oxidized and decomposed at the potential that can be endured by the component of the lithium rechargeable battery presently put in use, but will be able to be used when the potential that can be endured by the general battery component becomes higher in the future. Other compounds are used as a supporting salt in the general lithium rechargeable battery, but can belong to the oxidizable agent as long as the compounds are decomposed by charging the battery at a high potential that causes the battery capacity recovering unit to work.

For example, lithium salts are selected from among the above compounds because the lithium salts can be expected to contribute to the battery reaction. The compound containing a lithium element is used as the oxidizable agent, so that an active lithium element is generated as an oxidation product made by the oxidation and decomposition, which can be expected to have the effect of recovering the battery capacity.

The positive-electrode active material is not limited to a specific one, but includes a lithium-containing transition metal oxide as an example. The lithium-containing transition metal oxide is a material into and from which Li+ ions can be inserted and desorpted, and can include a lithium-metal composite oxide having a layered structure or a spinel structure, as an example. Specifically, the positive-electrode active material can contain one or more elements selected from the group consisting of Li_{1-z}NiO₂, Li_{1-z}MnO₂, Li_{1-z}Mn₂O₄, Li_{1-z}CoO₂, Li_{1-z}CoₓMn_{y}Ni_{(1-x-y)}O₂, and Li_{1-z}βPO₄(in which β is Fe, for example, LiFePO₄ and the like). In the examples, z is equal to or greater than 0, but less than 1, and x and y are not less than 0 nor greater than 1. Li, Mg, Al, or a transition metal, such as Co, Ti, Nb, or Cr, may be added to or substituted for each element described above. Such a lithium-metal composite oxide is independently used. Alternatively, a plurality of kinds of these oxides can be mixed and used. Further, a conductive polymer material or material having radicals can also be mixed.

The negative-electrode active material can include carbon materials, such as graphite or amorphous carbon. These active materials promote the insertion and desorption of the lithium (ions) together with the progress of the battery reaction. When the charging and discharging operations are repeated together with the use of the battery, parts of the lithium (ions) are inactivated without being desorbed. The charging apparatus of the present disclosure provides new lithium in place of the inactivated lithium to compensate for the inactivated lithium, and thus can recover the reduced battery capacity.

The electrolyte is not limited to a specific material, and often affects the kind of the added oxidizable agent. That is, the material included in the electrolyte has an oxidation decompression potential less than that of material included in the positive and negative electrodes in many cases. By appropriately selecting the electrolyte, the lithium rechargeable battery can contain a wide variety of oxidizable agents. For example, each of ethylene carbonate (EC), propylene carbonate (PC), dimethyl carbonate (DMC), ethyl methyl carbonate (EMC), and diethyl carbonate (DEC) has a high oxidation decompression potential of 4.3 V or more, and thus can be used as a solvent of the electrolyte, which enhances the stability of the lithium rechargeable battery, and offers a broad range of choices about the oxidizable agent.

In addition to these solvents, organic solvents that are normally used for an electrolyte solution of a lithium rechargeable battery can be used. For example, a carbonate other than the above carbonates, a halogenated hydrocarbon, an ether, a ketone, a nitrile, a lactone, an oxolane compound, and the like can be used. In particular, a propylene carbonate, an ethylene carbonate, 1,2-dimethoxyethane, dimethyl carbonate, diethyl carbonate, ethylmethyl carbonate, and a mixture of these solvents can be used. In particular, a solvent with a substituent group having an electron suction property, such as a fluorinated group or a cyano group, can be used to increase the oxidation decompression potential. The supporting salt can serve as the electrolyte by being dissolved into such a solvent.

The supporting salt is not limited to a specific one, but can include salt compounds, for example, LiPF₆, LiBF₄, LiAsF₆, LiCF₃SO₃, LiN(CF₃SO₂)₂, LiC(CF₃SO₂)₃, LiSbF₆, LiSCN, LiClO₄, LiAlCl₄, NaClO₄, NaBF₄, NaI, and a derivative thereof. Among them, the use of one or more kinds of salts selected from the group consisting of LiPF₆, LiBF₄, LiClO₄, LiAsF₆, LiCF₃SO₃, LiN(CF₃SO₂)₂, LiC(CF₃SO₂)₃, LiN(FSO₂)₂, LiN(CF₃SO₂)(C₄F₉SO₂), a derivative of LiCF₃SO₃, a derivative of LiN(CF₃SO₂)₂, and a derivative of LiC(CF₃SO₂)₃ is exemplarily used from the viewpoint of electric characteristics.

In addition to or instead of the above electrolyte, an ion solution used for the electrolyte solution of the normal lithium rechargeable battery can be used. A cation component of the ion solution can include an N-methyl-N-propylpiperidinium, a dimethyl-ethyl methoxy ammonium cation, or the like. An anion component of the ion solution can include BF⁴⁻, N(SO₂CF₃)²⁻, or the like.

<Charging Apparatus for Lithium Secondary Battery>

The charging apparatus according to the present embodiment is a device for charging the lithium rechargeable battery. Further, not only a charging operation of the charging apparatus, but also a discharging operation thereof may be controlled. Specifically, the charging apparatus according to the present embodiment is the device adapted to perform at least the charging operation of the lithium rechargeable battery in a plurality of charging and discharging cycles, and thus includes a battery capacity recovering unit. The battery capacity recovering unit performs a charging operation to charge the lithium rechargeable battery at a potential equal to or greater than an oxidation potential of the oxidizable agent among a part of a plurality of number of times of charging and discharging cycles performed by the charging apparatus. That is, the charging apparatus includes a charging unit (section) for performing the normal charging operation of the battery, and the battery capacity recovering unit (section) for charging the battery at a potential greater than that of the normal charging operation. The potential greater than that of the normal charging unit is selected so as to be less than the potential for causing the decomposition of the component of the lithium rechargeable battery as the upper limit.

For example, a supporting salt is dissolved into an organic solvent as the electrolyte, such as EC, PC, DMC, EMC, and/or DEC to form the electrolyte. In use of the electrolyte, the oxidation decomposition potential of such an organic solvent is 4.3 V or more, and hence the potential of charging at which the battery capacity recovering unit charges the battery is desirably 4.3 V or less. Specifically, when the nominal voltage is about 3.6 V, the potential of charging performed on the battery by the battery capacity recovering unit for use can be 3.7 V (nominal voltage +0.1V), 3.8 V (nominal voltage +0.2 V), 3.9 V (nominal voltage +0.3V), 4.0 V (nominal voltage +0.4 V), 4.1 V (nominal voltage +0.5 V), 4.2 V (nominal voltage +0.6 V), and 4.3 V (nominal voltage +0.7 V).

A period of time during which the battery capacity recovering unit charges the battery is not limited to a specific one, but desirably in a range of about one to 10 hours. As the charging time becomes longer, the oxidation and decompression is promoted greater than necessary, which wastes the oxidizable agent. When the charging time is too short, the oxidation and decompression is not sufficiently performed, which results in a small amount of recovery of the battery capacity. The charging may be continuously performed, or may be discontinuously performed.

The reason why the battery capacity recovering unit charges the battery at a high potential is that the high potential is applied to the oxidizable agent to decompose the oxidizable agent so as to compensate for lithium. Thus, the repetition of each brief operation of the battery recovering unit can be expected to have the effect of recovering the battery capacity.

The degree of recovery of the battery capacity after one operation of the battery capacity recovering unit is not limited to a specific value, but is desirably in a range of not less than 5% nor greater than 20% respective to the battery capacity obtained immediately before the operation of the battery capacity recovering unit. The degree of recovery can be easily controlled by increasing and decreasing the integrated value of current in constant-voltage charge.

The frequency of the operation of the battery capacity recovering unit is a part of the plurality of charging cycles. Preferably, during greater than half the charging cycles, the normal charging unit performs the charging operation. The operation of the battery capacity recovering unit can be controlled as follows.

### Use of Battery Capacity as Reference

The charging apparatus of the present embodiment includes the battery capacity measuring unit for measuring a battery capacity. When the battery capacity measured by the battery capacity measuring unit is decreased to a certain rate or less with reference to the initial battery capacity, the battery capacity recovering unit is operated in some cases. The battery capacity is directly measured, and the battery capacity recovering unit is operated according to the reduction in battery capacity, whereby the battery capacity can be recovered at a necessary and sufficient frequency. The term “certain rate” as used herein is not limited to a specific one, but can be set to about 0.6 to 0.99 times, and for example about 0.95 times as large as the initial battery capacity serving as the reference.

The upper limit of the degree of recovery of the battery capacity by the battery capacity recovering unit is desirably the degree at which the battery capacity is returned to the initial battery capacity. For example, when the certain rate is 0.95 times, the battery capacity recovering unit is desirably operated until the battery capacity is recovered up to around the initial battery capacity.

The battery capacity recovering unit can also be operated until the battery capacity is recovered to a level which is slightly less than the initial battery capacity, and not to the initial battery capacity. The battery capacity recovering unit is operated, while measuring the battery capacity by the battery capacity measuring unit until a target battery capacity is reached. Alternatively, the battery capacity recovering unit is operated only until the target battery capacity is supposed to be reached without measuring the battery capacity. The battery capacity recovering unit is operated for a predetermined time, which is easily controlled. Thus, the battery can be desirably restricted from being exposed at the high potential for a long time greater than necessary when the battery capacity is not recovered to the desired degree. The degree of recovery of the battery capacity can be previously estimated from the period of time in which the battery capacity recovering is operated, so that the appropriate operation time can be set.

The battery capacity measuring unit is not limited to a specific one. For example, the battery capacity measuring unit can employ one of or a combination of an element for measuring a battery capacity from a terminal voltage, an element for measuring a battery capacity from an integrated value of charging and discharging currents, an element for measuring a battery capacity using appropriate means, and the like.

When the measured battery capacity is decreased to the certain rate or less with respect to the initial battery capacity as a reference, the battery capacity recovering unit is operated. Alternatively, the battery capacity recovering unit can also be operated when the measured battery capacity is decreased to the certain rate or less with respect to the battery capacity obtained immediately after when the battery capacity recovering unit was operated at the last (or last but one) time.

### Use of Number of Times of Charging Operations as Reference

The battery capacity recovering unit can be operated according to the number of times of charging operations without taking into consideration the battery capacity (or in addition to consideration thereof). That is, the battery capacity recovering unit can be operated every time the number of times of charging operations reaches the predetermined number of times. Alternatively, the battery capacity recovering unit can be operated at a predetermined probability every charging operation. When the battery capacity recovering unit is operated using the number of times of charging operations as a reference, the frequency of operation of the recovering unit can be about one to three times per 100 times in total of the number of times of charging operations. Not only when charging and discharging operations are alternatively performed continuously at a predetermined depth, but also when the integrated charging level proceeds at the predetermined depth, one-time charging operation is determined to be performed. For example, when the integrated amount of charging reaches 100% based on the SOC reference, the one-time charging operation is determined to be performed regardless of the continuity or discontinuity of the charging operation. The SOC is an index indicative of the remaining capacity of the battery in a case where a battery capacity at the lower limit of the voltage range in the normal use is set to 0% and a battery capacity at the upper limit thereof is set to 100%.

The reduction in battery capacity is preferably combined with the number of times of charging operations. That is, only when the battery capacity is decreased to the certain rate or less and the number of times of charging operations reaches the predetermined number, the battery capacity recovering unit is operated. Thus, the battery capacity recovering unit can be appropriately operated while avoiding the adverse effect on the lithium rechargeable battery due to the excessive operation of the battery capacity recovering unit.

<Charging Method of Lithium Secondary Battery>

A charging method according to the present embodiment is a method for charging the lithium rechargeable battery. In the method, the battery may be not only charged, but also discharged. Specifically, the charging method according to the present embodiment is a method regarding at least a charging operation of the lithium rechargeable battery among the plurality of charging and discharging cycles. The method includes a step of recovering the battery capacity. The battery capacity recovering step is a step of constant-voltage charge at a potential equal to or greater than the oxidation potential of the oxidizable agent among the charging operations performed by the charging method of the present embodiment.

The battery capacity recovering step is a step of performing substantially the same operation as that performed by the battery capacity recovering unit of the above-mentioned charging apparatus, and thus a more detailed description thereof will be omitted below.

### EXAMPLE

Now, the charging apparatus for the lithium rechargeable battery and the charging method thereof according to the present embodiment will be described in detail below based on the following example.

### Manufacturing of Test Battery

A coin type battery was prepared as a test battery. The battery was a lithium rechargeable battery including a lithium ion composite oxide used as the positive-electrode active material and represented by the composition LiFePO₄, and a graphite used as the negative-electrode active material.

The positive electrode was manufactured in the following way. First, 80 parts by mass of the above LiFePO₄, 10 parts by mass of acetylene black as a conductive material, and 10 parts by mass of poly vinylidene difluoride (PVDF) as a binder were mixed together, to which an N-methyl-2-pyrrolidone was added in an appropriate amount. This solution was kneaded and mixed to form a paste-like positive electrode mixture. The positive electrode mixture was applied to both sides of a positive-electrode current collector made of an aluminum foil in a thickness of 15 μm and then dried to be subjected to a pressing process, so that a sheet-like positive electrode was produced.

The negative electrode was manufactured in the following way. First, 98 parts by mass of graphite, and 1 part by mass of each of carboxy methyl cellulose (CMC) and stylene butadiene rubber (SBR) were mixed as a binder, to which an N-methyl-2-pyrrolidone was added in an appropriate amount. This solution was kneaded and mixed to form a paste-like negative electrode mixture. The negative electrode mixture was applied to both sides of a negative-electrode current collector made of a copper foil in a thickness of 10 μm and then dried to be subjected to a pressing process, whereby a sheet-like negative electrode was produced.

The electrolyte solution used was a mixed solvent of EC, DMC, and EMC mixed at a ratio of volume of 3:3:4 to which lithium salts shown in Table 1 were dissolved. A lithium salt “A” corresponds to a support salt of the normal lithium rechargeable battery, and a lithium salt “B” is a compound corresponding to the oxidizable agent of the present disclosure. The lithium salt “B” is a compound having an oxidation potential greater than 3.6 V and less than 4.3 V as the upper limit of voltage in the normal use of the lithium rechargeable battery. A Li salt of tetraethylboron (in each of testing examples No. 1 to 4), a Li salt of tetramethyl boron (in each of testing examples No. 5 to 8), a lithium acetate (in each of testing examples No. 9 to 12), Li₂B₁₂F₁₂ (in each of testing examples No. 13 to 16), LiBOB (in each of testing examples No. 17 to 20), LiFOB (in each of testing examples No. 21 to 24), and LiFSI (in each of testing examples No. 25 to 28) were adopted. In each of testing examples No. 29 to 32, the lithium salt B was not added.

A separator made of polypropylene was sandwiched between and superimposed on the positive electrode and the negative electrode obtained as described to thereby form a flat-plate like electrode member. The thus-obtained flat-plate like electrode member was inserted into a case and held by the case. Then, after the electrolyte was charged into the case holding the flat-plate like electrode member, the case was hermetically sealed, so that the lithium rechargeable batteries of the testing examples No. 1 to 32 were completed.

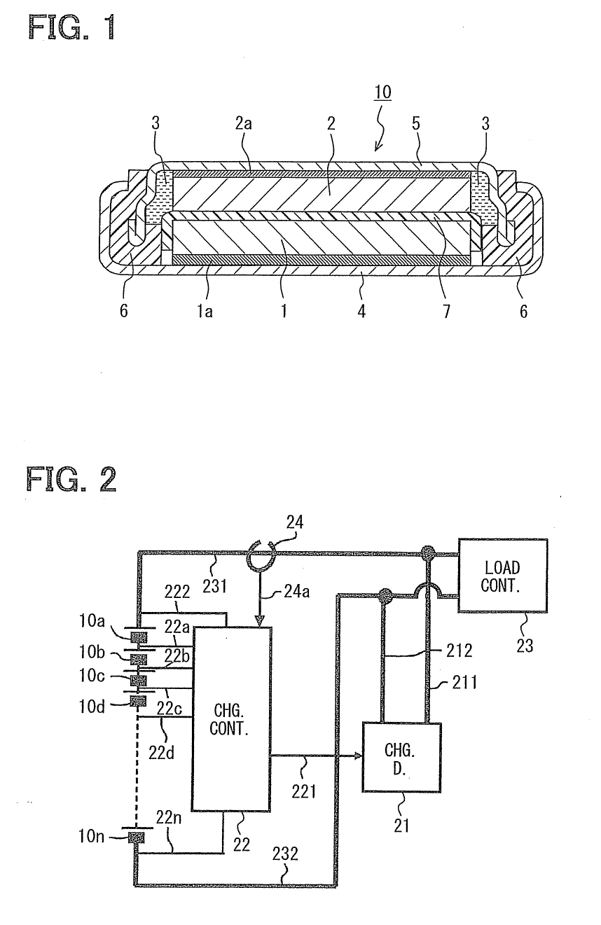

Specifically, as shown in FIG. 1, a positive electrode 1 was made using the above-described positive electrode, and a negative electrode 2 was made using the above-described negative electrode. An electrolyte 3 was made using the above prepared electrolyte solution. A separator 7 was a porous film having a thickness of 25 μm and made of polyethylene. These components were used to manufacture the coin type battery. The positive electrode 1 included a positive electrode current collector 1a, and the negative electrode 2 included a negative electrode current collector 2a.

These electricity generation elements were accommodated in a stainless case made of a positive electrode case member 4 and a negative electrode case member 5. The positive electrode case member 4 and the negative electrode case member 5 also served as a positive electrode terminal and a negative electrode terminal, respectively. A gasket 6 made of polypropylene intervened in between the positive electrode case member 4 and the negative electrode case member 5, which ensured the sealing properties and insulating properties between the positive electrode case member 4 and the negative electrode case member 5. In the above procedure, the coin type battery having a diameter φ of 19 mm and a thickness of 3 mm was manufactured as the test battery of the present example.

### Charging Apparatus

FIG. 2 shows the schematic block diagram of the charging apparatus for the lithium rechargeable battery of the present example. The charging apparatus of the present example is a device for charging a plurality of lithium rechargeable batteries 10a to 10n coupled together in series. The charging apparatus includes a charging device 21 serving as a part of the battery capacity recovering unit or charging unit, a charging controller 22 including therein a remaining part of the battery capacity recovering unit as a logic, and an ammeter 24. The combination of the controller 22 and the charging device 21 exhibits the effect of the battery capacity recovering unit.

Power output from each of the rechargeable batteries 10a to 10n is supplied to the load via a load controller 23. The charging device 21 supplies the power supplied from an external power source (not shown) to the respective rechargeable batteries 10a to 10n via power lines 211, 212, 231, and 232. Then, the controller 22 calculates the charged and discharged state of the rechargeable batteries 10a to 10n based on a current signal 24a from the ammeter 24 for measuring a current flowing through the power line 231, and a terminal voltage of each rechargeable battery measured by each of a potential measuring lines 222, and 22a to 22n thereby to measure a SOC of the battery and a battery capacity.

The charging device 21 is controlled by a control signal 221 from the controller 22 based on the measured battery capacity and SOC. In this case, based on the control signal 221, the charging device 21 switches between the effect of the normal charging unit and the effect of the battery capacity recovering unit for charging the battery at a potential greater than that of the normal charging unit.

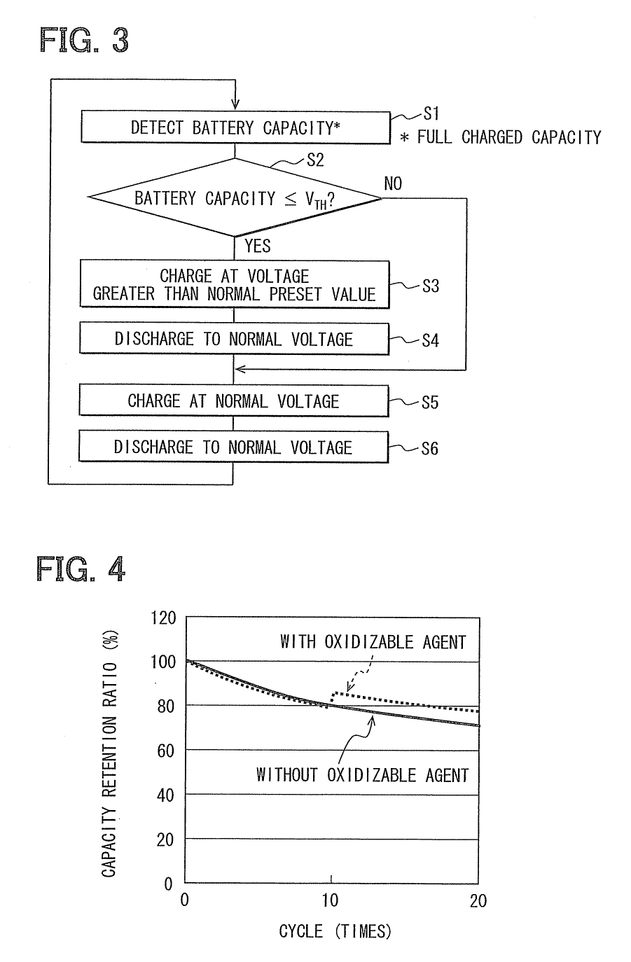

Now, a control method of the charging apparatus according to the present example will be described below based on FIG. 3. As shown in FIG. 3, a battery capacity is detected from a current signal 24a and a measured voltage at S1. It is determined at S2 whether or not the measured battery capacity is equal to or less than a predetermined threshold V_{TH} (corresponding to the certain level). When the measured battery capacity exceeds the threshold V_{TH}, the operation of S5 is performed. When the measured battery capacity is equal to or less than the threshold V_{TH}, the charging device 21 is controlled to charge the battery at a potential greater than the preset value in the normal use at S3 (battery capacity recovering step). Then, the discharging is continued until the normal voltage is reached, whereby the battery capacity is measured at S4. The charging device 21 is controlled to charge the battery at the normal voltage at S5. Thereafter, the battery continues to be discharged until the battery has the normal voltage at S6. Then, the operation returns to the operation of S1. The charging and discharging operations are repeatedly performed.

After setting the appropriate threshold, the charging and discharging test was performed on each test battery by using the charging apparatus. As a result, after the charging and discharging were repeatedly performed until the battery capacity was decreased from the initial capacity to a reduced capacity shown in Table 1, a charging operation (battery capacity recovering step) was performed for a CV time at a CV voltage shown in Table 1. A battery capacity after the battery capacity recovering step was measured, and then a recovered battery capacity and a ratio of the recovered capacity to the reduced capacity were shown in Table 1. FIG. 4 shows a capacity retention ratio (in setting the initial battery capacity to 100%) obtained when the cycle test was performed on the batteries with or without the lithium salt B.

In the test shown in FIG. 4, the battery capacity recovering step was performed in the tenth cycle.

TABLE 1

| | Li salt A | | Li salt B | | | | | | | Capacity |
|---|---|---|---|---|---|---|---|---|---|---|
| | | Added | | Added | CV | | Initial | Reduced | Recovered | recovery |
| | | amount | | amount | potential | CV time | capacity | capacity | capacity | ratio |
| | Material | mol/L | Material | mol/L | V | h | mAh | mAh | mAh | % |
| Testing example 1 | LiPF₆ | 1 | LiB(C₂H₅)₄ | 0.3 | 3.8 | 10 | 3.231 | 2.524 | 3.036 | 120.3% |
| Testing example 2 | LiPF₆ | 1 | LiB(C₂H₅)₄ | 0.3 | 4.0 | 10 | 3.221 | 2.541 | 3.051 | 120.1% |
| Testing example 3 | LiPF₆ | 1 | LiB(C₂H₅)₄ | 0.3 | 4.2 | 10 | 3.303 | 2.599 | 3.129 | 120.4% |
| Testing example 4 | LiPF₆ | 1 | LiB(C₂H₅)₄ | 0.3 | 4.3 | 10 | 3.303 | 2.621 | 3.203 | 122.2% |
| Testing example 5 | LiPF₆ | 1 | LiB(CH₃)₄ | 0.3 | 3.8 | 10 | 3.26 | 2.579 | 3.084 | 119.6% |
| Testing example 6 | LiPF₆ | 1 | LiB(CH₃)₄ | 0.3 | 4.0 | 10 | 3.302 | 2.582 | 3.099 | 120.0% |
| Testing example 7 | LiPF₆ | 1 | LiB(CH₃)₄ | 0.3 | 4.2 | 10 | 3.284 | 2.599 | 3.129 | 120.4% |
| Testing example 8 | LiPF₆ | 1 | LiB(CH₃)₄ | 0.3 | 4.3 | 10 | 3.272 | 2.657 | 3.202 | 120.5% |
| Testing example 9 | LiPF₆ | 1 | CH₃COOLi | 0.3 | 3.8 | 10 | 3.225 | 2.62 | 2.625 | 100.2% |
| Testing example 10 | LiPF₆ | 1 | CH₃COOLi | 0.3 | 4.0 | 10 | 3.241 | 2.573 | 2.638 | 102.5% |
| Testing example 11 | LiPF₆ | 1 | CH₃COOLi | 0.3 | 4.2 | 10 | 3.295 | 2.674 | 2.858 | 106.9% |
| Testing example 12 | LiPF₆ | 1 | CH₃COOLi | 0.3 | 4.3 | 10 | 3.26 | 2.646 | 3.043 | 115.0% |
| Testing example 13 | LiPF₆ | 1 | Li₂B₁₂F₁₂ | 0.3 | 3.8 | 10 | 3.227 | 2.552 | 2.552 | 100.0% |
| Testing example 14 | LiPF₆ | 1 | Li₂B₁₂F₁₂ | 0.3 | 4.0 | 10 | 3.253 | 2.566 | 2.568 | 100.1% |
| Testing example 15 | LiPF₆ | 1 | Li₂B₁₂F₁₂ | 0.3 | 4.2 | 10 | 3.292 | 2.667 | 2.68 | 100.5% |
| Testing example 16 | LiPF₆ | 1 | Li₂B₁₂F₁₂ | 0.3 | 4.3 | 10 | 3.272 | 2.579 | 2.666 | 103.4% |
| Testing example 17 | LiPF₆ | 1 | LiBOB | 0.3 | 3.8 | 10 | 3.267 | 2.637 | 2.637 | 100.0% |
| Testing example 18 | LiPF₆ | 1 | LiBOB | 0.3 | 4.0 | 10 | 3.25 | 2.6 | 2.6 | 100.0% |
| Testing example 19 | LiPF₆ | 1 | LiBOB | 0.3 | 4.2 | 10 | 3.263 | 2.619 | 2.635 | 100.6% |
| Testing example 20 | LiPF₆ | 1 | LiBOB | 0.3 | 4.3 | 10 | 3.248 | 2.617 | 2.656 | 101.5% |
| Testing example 21 | LiPF₆ | 1 | LiFOB | 0.3 | 3.8 | 10 | 3.235 | 2.642 | 2.642 | 100.0% |
| Testing example 22 | LiPF₆ | 1 | LiFOB | 0.3 | 4.0 | 10 | 3.255 | 2.65 | 2.65 | 100.0% |
| Testing example 23 | LiPF₆ | 1 | LiFOB | 0.3 | 4.2 | 10 | 3.226 | 2.573 | 2.573 | 100.0% |
| Testing example 24 | LiPF₆ | 1 | LiFOB | 0.3 | 4.3 | 10 | 3.267 | 2.571 | 2.576 | 100.2% |
| Testing example 25 | LiPF₆ | 1 | LiFSI | 0.3 | 3.8 | 10 | 3.243 | 2.624 | 2.624 | 100.0% |
| Testing example 26 | LiPF₆ | 1 | LiFSI | 0.3 | 4.0 | 10 | 3.211 | 2.526 | 2.526 | 100.0% |
| Testing example 27 | LiPF₆ | 1 | LiFSI | 0.3 | 4.2 | 10 | 3.296 | 2.641 | 2.641 | 100.0% |
| Testing example 28 | LiPF₆ | 1 | LiFSI | 0.3 | 4.3 | 50 | 3.294 | 2.618 | 2.621 | 100.1% |
| Testing example 29 | LiPF₆ | 1 | None | — | 3.8 | 10 | 3.258 | 2.628 | 2.628 | 100.0% |
| Testing example 30 | LiPF₆ | 1 | None | — | 4.0 | 10 | 3.273 | 2.651 | 2.651 | 100.0% |
| Testing example 31 | LiPF₆ | 1 | None | — | 4.2 | 10 | 3.274 | 2.635 | 2.635 | 100.0% |
| Testing example 32 | LiPF₆ | 1 | None | — | 4.3 | 10 | 3.262 | 2.654 | 2.654 | 100.0% |

As can be seen from Table 1, the rechargeable battery to which the lithium salt B (oxidizable agent) was added had its battery capacity recovered after the battery capacity recovering step regardless of the level of the CV potential.

It can be shown that the testing examples containing the lithium salt B added as a compound having an oxidation potential of greater than 3.6 V as the nominal voltage and less than 4.3 V had the battery capacity recovering effect. After the battery capacity recovering step, regardless of the level of the CV potential, any one of the examples exhibited the battery capacity recovering effect.

The Li salt of the boron exhibited the battery capacity recovering effect in all of the testing examples No. 1 to 4. As the CV potential was increased, the effect became more. The Li salt of the tetramethyl boron exhibited the battery capacity recovering effect in all of the testing examples No. 5 to 8. As the CV potential was increased, the effect became more. The lithium acetate also exhibited the battery capacity recovering effect in all of the testing examples No. 9 to 12. As the CV potential was increased, the effect became more. The Li₂B₁₂F₁₂ did not have the great effect at a CV potential of 3.8 V, but exhibited the high battery capacity recovering effect in the testing examples No. 14 to 16 having a CV potential of greater than 3.8 V. LiBOB did not exhibit the great effect until the CV potential of 4.0 V, but exhibited the high battery capacity recovering effect in testing examples No. 19 and 20 having a CV potential exceeding 4.0 V. LiFOB and LiFSI did not exhibit the great effects in a range of a CV potential of 4.2 V or less, but exhibited the high battery capacity recovering effect in the testing examples No. 24 and 28 having a CV potential exceeding 4.2 V.

The testing examples No. 29 to 32 without addition of the lithium salt B did not exhibit the battery capacity recovering effect even in use of the high CV potential. It can be shown that the presence of the lithium salt B exhibited the battery capacity recovering effect.

The battery capacity recovering effect which was detectable was not exhibited in the testing examples No. 13, 17, 18, 21, 22, 23, 25, 26, and 27, but will be supposed to be possibly exhibited from a testing result obtained by charging the battery at a more CV potential.

In an embodiment, a charging apparatus is adapted to charge a lithium rechargeable battery which includes positive and negative electrodes containing active materials that allow absorption and discharge of lithium ions, and an electrolyte.

The lithium rechargeable battery contains, in at least one of the electrolyte and the positive electrode, an oxidizable agent which is oxidizable by the positive electrode and which has an oxidation potential greater than a nominal voltage of the lithium rechargeable battery and less than a decomposition potential of the electrolyte. The charging apparatus includes a battery capacity recovering unit that charges the lithium rechargeable battery at a potential equal to or greater than the oxidation potential of the oxidizable agent in a part of a plurality of number of times of charging and discharging cycles.

The lithium rechargeable battery of interest to be charged includes the oxidizable agent, which is oxidizable at the positive electrode and which has the oxidation potential greater than the nominal voltage of the lithium rechargeable battery and less than the decomposition potential of the electrolyte. The charging apparatus includes the means or unit for increasing a charging potential up to a potential at which the oxidizable agent can be oxidized and decomposed.

When charging the related art lithium rechargeable battery, a lithium is discharged from the positive electrode, and the lithium is introduced into the negative electrode, which does not change the total amount of lithium within the positive and negative electrodes. However, when the rechargeable battery contains the oxidizable agent, the oxidizable agent is oxidized upon charging, whereby the lithium can be introduced into the negative electrode without the reversible oxidation-reduction reaction including insertion and discharge of lithium at the positive electrode. As a result, the amount of active lithium is increased to thereby increase the battery capacity.

In the above-described charging apparatus according to the embodiment, the frequency of oxidation and decomposition of the oxidizable agent is restricted by increasing the charging potential, which can suppress the adverse effect on components of the battery.

In an embodiment, a charging apparatus includes a battery capacity measuring unit that measures a battery capacity of the lithium rechargeable battery. The battery capacity recovering unit charges the battery at a potential equal to or greater than the oxidation potential of the oxidizable agent when the measured battery capacity is decreased to a certain rate with respect to an initial battery capacity of the lithium rechargeable battery as the reference.

The battery capacity recovering unit charges the lithium rechargeable battery at the potential equal to or greater than the oxidation potential according to the reduction in battery capacity, so that the battery capacity can be recovered at a frequency close to a sufficient frequency if necessary.

In an embodiment, a charging apparatus includes a battery capacity measuring unit that measures a battery capacity of the lithium rechargeable battery. The battery capacity recovering unit charges the lithium rechargeable battery at a potential equal to or greater than the oxidation potential of the oxidizable agent when the measured battery capacity is decreased to the certain rate with respect to the battery capacity as the reference obtained immediately after the previous charge of the lithium rechargeable battery at the potential equal to or greater than the oxidation potential of the oxidizable agent.

The battery capacity recovering unit charges the lithium rechargeable battery at the potential equal to or greater than the oxidation potential according to the reduction in battery capacity, so that the battery capacity can be recovered at a frequency close to a sufficient frequency if necessary. The reference for determining the reduction in battery capacity for use is the battery capacity obtained immediately after the previous charge at the potential equal to or greater than the oxidation potential of the oxidizable agent. When the battery capacity is greatly reduced, for example, at an end stage of a battery lifetime, the battery capacity can be restricted from being recovering at a frequency greater than necessary, whereby the battery capacity can be appropriately recovered without giving an adverse effect on the battery characteristics. Thus, the characteristics of the battery can be kept for a long time. The phrase “battery capacity obtained immediately after the previous charge at the potential equal to or greater than the oxidation potential of the oxidizable agent” for use can mean not only the battery capacity obtained at the last time of recovering of the battery capacity, but also a battery capacity obtained at the second last time of recovering of the battery capacity, and a battery capacity obtained at the third last time of recovering of the battery capacity.

In an embodiment, the battery capacity recovering unit charges the lithium rechargeable battery at the potential equal to or greater than the oxidation potential of the oxidizable agent at least every predetermined number of times.

The arrangement for recovering the battery capacity at least every predetermined number of times, regardless of the battery capacity, can be used to recover the battery capacity at an appropriate frequency without measuring the battery capacity.

In an embodiment, the battery capacity recovering unit charges the battery at the potential equal to or greater than the oxidation potential of the oxidizable agent at a predetermined probability.

The arrangement for recovering the battery capacity at least at the predetermined probability, regardless of the battery capacity, can be used to recover the battery capacity at an appropriate frequency without measuring the battery capacity.

In an embodiment, the oxidizable agent includes one or more compounds selected from the group consisting of lithium bis(oxalate)borate, lithium difluoro oxalate borate, Li₂B₁₂F₁₂, boryl lithium, a Li salt of tetramethyl boron, a Li salt of tetraethylboron, a Li salt of tetrapropylboron, a Li salt of tetrabutylboron, a Li salt of trimethylethylboron, a Li salt of trimethylbenzylboron, a Li salt of trimethylphenylboron, a Li salt of triethylmethylboron, a Li salt of triethylbenzylboron, a Li salt of triethylphenylboron, a Li salt of tributylmendylboron, a Li salt of tributylphenylboron, a Li salt of tetraphenyl boron, a Li salt of benzyltriphenylboron, a Li salt of methyltriphenylboron, a Li salt of buthyl triphenyl boron, a Li salt of tetramethylboron, bis(ethylenedithio)tetrathiafulvalene, benzoquinone, benzotriazole, naphthoquinone, fluorene, polyaniline, polypyrrole, polyethylene dioxythiophene, 4-aminopyridine, 2-aminopyridine, N,N-dimethyl-4-aminopyridine, 4-diethylaminopyridine, 2-hydroxypyridine, 2-methoxypyridine, 4-methoxypyridine, 2-dimethylaminoimidazole, 2-methoxyimidazole, imidazole, 2-mercaptoimidazole, 2-methylimidazole, aminoquinoline, LiClO₄, LiAlCl₄, LiAsF₆, LiBF₄, LiPF₆, LiSbF₆, LiB₁₀C₁₀, LiCF₃SO₃, LiCF₃CO₂, LiCl, LiBr, LiI, lithium lower aliphatic carboxylate, lithium chloloborane, lithium(2,4-pentanedionato), lithium 1,1,2,2,3,3-hexafluoropropane-1,3-disulfonimide, lithium acetate, lithium acetoacetate, lithium bis(trifluoromethanesulfonyl)imide, lithium carbonate, lithium diisopropyl amide, lithium-2-hydroxybutyrate, lithium formate, lithium hexamethyldisilazide, lithium-2-hydroxypropionate, lithium pyruvate, lithium tetrakis(pentafluorophenyl)borate, lithium trifluoromethanesulfonate, methyllithium, phenyllithium, dilithium phthalocyanine, lithium salicylate, tert-butyllithium, LiNH₂SO₃, Li₄SiO₄, Li₃PO₄, Li₂TiO₃, Li₂ZrO₃, Li₂AlO₂, Li₄ZrO₄, Li₄GeO₄, Li₂S—SiS₂—Li₄SiO₄, Li₂O—Nb₂O₅, Li₂O—B₂O₃—LiCl, and Li₂S—P₂S₅.

It is easy to select a compound having an oxidation decomposition potential less than that of a component of a general lithium rechargeable battery, such as an electrolyte, and greater than a general working potential, from among the above-mentioned compounds. The oxidation and decomposition of such a compound recovers the battery capacity. In particular, the lithium salt compound is desirable because it contributes to a normal battery reaction. It is noted that some compounds described above cannot be oxidized at a potential that can be endured by the presently predominant lithium rechargeable battery component. However, these compounds will be able to be decomposed if the development of materials for batteries enables the use of the battery in the future at a potential greater than that at present.

In an embodiment, a charging method is directed to a method for charging a lithium rechargeable battery which includes positive and negative electrodes containing active materials that allow absorption and discharge of lithium ions, and an electrolyte. The lithium rechargeable battery contains an oxidizable agent which is oxidizable by the positive electrode and which has an oxidation potential greater than a nominal voltage of the lithium rechargeable battery and less than a decomposition potential of the electrolyte. In the method, a battery capacity is recovered by charging the lithium rechargeable battery at a potential equal to or greater than the oxidation potential of the oxidizable agent at a frequency of one or more number of times in a plurality of number of times of charging and discharging cycles.

In such a method, the charging potential is increased to a potential at which the oxidizable agent contained in and oxidizable by the positive electrode can be oxidized. The oxidizable agent has the oxidation potential greater than the nominal voltage of the lithium rechargeable battery and less than the decomposition potential of the electrolyte. As a result, the oxidation of the oxidizable agent can insert the lithium of the electrolyte into the negative electrode without the reversible oxidation-reduction reaction including insertion and discharge of lithium at the positive electrode, thereby to recover the battery capacity.

In the method, the frequency of increasing the charging potential is restricted, which can suppress the adverse effect on the components of the battery.

Additional advantages and modifications will readily occur to those skilled in the art. The invention in its broader term is therefore not limited to the specific details, representative apparatus, and illustrative examples shown and described.

What is claimed is:

1. A charging apparatus comprising:
a lithium rechargeable battery including positive and negative electrodes containing active materials that allow absorption and discharge of lithium ions, and an electrolyte, the lithium rechargeable battery containing, in at least one of the electrolyte and the positive electrode, an oxidizable agent which is oxidizable by the positive electrode and which has an oxidation potential greater than a nominal voltage of the lithium rechargeable battery and less than a decomposition potential of the electrolyte; and
a battery capacity recovering unit that charges the lithium rechargeable battery at a potential equal to or greater than the oxidation potential of the oxidizable agent in a part of a plurality of number of times of charging and discharging cycles.

2. The charging apparatus according to claim 1, further comprising:
a battery capacity measuring unit that measures a battery capacity of the lithium rechargeable battery,
wherein the battery capacity recovering unit charges the lithium rechargeable battery at a potential equal to or greater than the oxidation potential of the oxidizable agent when a measured battery capacity is decreased to a predetermined rate with respect to an initial battery capacity of the battery as a reference.

3. The charging apparatus according to claim 1, further comprising:
a battery capacity measuring unit that measures a battery capacity of the lithium rechargeable battery,
wherein the battery capacity recovering unit charges the lithium rechargeable battery at a potential equal to or greater than the oxidation potential of the oxidizable agent when a measured battery capacity is decreased to a predetermined rate with respect to the battery capacity as a reference obtained immediately after a previous charge at the potential equal to or greater than the oxidation potential of the oxidizable agent.

4. The charging apparatus according to claim 1, wherein
the battery capacity recovering unit charges the lithium rechargeable battery at a potential equal to or greater than the oxidation potential of the oxidizable agent at least every predetermined number of times.

5. The charging apparatus according to claim 1, wherein
the battery capacity recovering unit charges the lithium rechargeable battery at a potential equal to or greater than the oxidation potential of the oxidizable agent at a predetermined probability.

6. The charging apparatus according to claim 1, wherein
the oxidizable agent includes one or more compounds selected from the group consisting of lithium bis(oxalate)borate, lithium difluoro oxalate borate, Li₂B₁₂F₁₂, boryl lithium, a Li salt of tetramethyl boron, a Li salt of tetraethylboron, a Li salt of tetrapropylboron, a Li salt of tetrabutylboron, a Li salt of trimethylethylboron, a Li salt of trimethylbenzylboron, a Li salt of trimethylphenylboron, a Li salt of triethylmethylboron, a Li salt of triethylbenzyl boron, a Li salt of triethylphenylboron, a Li salt of tributylmendylboron, a Li salt of tributylphenylboron, a Li salt of tetraphenylboron, a Li salt of benzyltriphenylboron, a Li salt of methyltriphenylboron, a Li salt of buthyl triphenyl boron, a Li salt of tetramethylboron, bis(ethylenedithio)tetrathiafulvalene, benzoquinone, benzotriazole, naphthoquinone, fluorene, polyaniline, polypyrrole, polyethylene dioxythiophene, 4-aminopyridine, 2-aminopyridine, N,N-dimethyl-4-aminopyridine, 4-diethylaminopyridine, 2-hydroxypyridine, 2-methoxypyridine, 4-methoxypyridine, 2-dimethylaminoimidazole, 2-methoxyimidazole, imidazole, 2-mercaptoimidazole, 2-methylimidazole, aminoquinoline, LiClO₄, LiAlCl₄, LiAsF₆, LiBF₄, LiPF₆, LiSbF₆, LiB₁₀C₁₀, LiCF₃SO₃, LiCF₃CO₂, LiCl, LiBr, LiI, lithium lower aliphatic carboxylate, lithium chloloborane, (2,4-pentanedionato)lithium, lithium 1,1,2,2,3,3-hexafluoropropane-1,3-disulfonimide, lithium acetate, lithium acetoacetate, lithium bis(trifluoromethanesulfonyl)imide, lithium carbonate, lithium diisopropyl amide, lithium-2-hydroxybutyrate, lithium formate, lithium hexamethyldisilazide, lithium-2-hydroxypropionate, lithium pyruvate, lithium tetrakis(pentafluorophenyl)borate, lithium trifluoromethanesulfonate, methyllithium, phenyllithium, dilithium phthalocyanine, lithium salicylate, tert-butyllithium, LiNH₂SO₃, Li₄SiO₄, Li₃PO₄, Li₂TiO₃, Li₂ZrO₃, Li₂AlO₂, Li₄ZrO₄, Li₄GeO₄, Li₂S—SiS₂—Li₄SiO₄, Li₂O—Nb₂O₅, Li₂O—B₂O₃—LiCl, and Li₂S—P₂S₅.

7. A method for charging a lithium rechargeable battery, the lithium rechargeable battery including positive and negative electrodes containing active materials that allow absorption and discharge of lithium ions, and an electrolyte, the lithium rechargeable battery containing an oxidizable agent which is oxidizable by the positive electrode and which has an oxidation potential greater than a nominal voltage of the lithium rechargeable battery and less than a decomposition potential of the electrolyte, the method comprising:
recovering a battery capacity by charging the battery at a potential equal to or greater than the oxidation potential of the oxidizable agent at a frequency of one or more number of times in a plurality of number of times of charging and discharging cycles.
